(19) United States
(12) Patent Application Publication
(10) Pub. No.: US 2003/0023689 A1
(43) Pub. Date: Jan. 30, 2003

(54) Editing messaging sessions for a record

(75) Inventors: Michael Wayne Brown, Georgetown, TX (US); Rabindranath Dutta, Austin, TX (US); Michael A. Paolini, Austin, TX (US)

Correspondence Address: International Business Machines Corporation, Intellectual Property Law Department, Internal Zip 4054, 11400 Burnet Road, Austin, TX, 78758, US

(73) Assignee: International Business Machines Corporation, Armonk, NY

(21) Appl. No.: 09/915,465

(22) Filed: Jul. 26, 2001

(51) Int. Cl. G06F 15/16

(52) U.S. Cl. 709/206; 709/203

(57) ABSTRACT

A method, system and program for editing a messaging session for a record are provided. A particular user from among multiple users associated with a messaging session is enabled to edit a messaging entry previously submitted in the messaging session. The edit to the messaging entry is then saved with the messaging session, such that the particular user is enabled to edit the messaging session prior to saving the messaging session as a record. In addition, the recorded messaging session with the edit to the messaging entry is distributed among the users associated with the messaging session.

### CROSS-REFERENCE TO RELATED APPLICATIONS

The present application is related to the following copending application, which are filed on even date herewith and incorporated herein by reference:

(1) U.S. patent application Ser. No. ______ (Attorney Docket No. AUS920010391US1);

(2) U.S. patent application Ser. No. ______ (Attorney Docket No. AUS920010392US1)

(3) U.S. patent application Ser. No. ______ (Attorney Docket No. AUS920010394US1);

(4) U.S. patent application Ser. No. ______ (Attorney Docket No. AUS920010396US1);

(5) U.S. patent application Ser. No. ______ (Attorney Docket No. AUS920010397US1);

(6) U.S. patent application Ser. No. ______ (Attorney Docket No. AUS920010528US1); and

(7) U.S. patent application Ser. No. ______ (Attorney Docket No. AUS920010553US1).

### BACKGROUND OF THE INVENTION

1. Technical Field

The present invention relates in general to electronic communications and, in particular, to editing messaging sessions. Still more particularly, the present invention relates to allowing users to edit message entries previously submitted within a messaging session, such that users are enabled to make corrections to message entries prior to storage as a record.

2. Description of the Related Art

As the Internet and telephony expand, the ease of communications between individuals in different locations continues to expand as well. One type of electronic communication is supported by messaging which includes the use of computer systems and data communication equipment to convey messages from one person to another, as by e-mail, voice mail, instant voice communications, instant text messaging, or fax.

While e-mail has already expanded into nearly every facet of the business world, other types of messaging continue to forge into use. For example, instant messaging systems are typically utilized in the context of an Internet-supported application that transfers text between multiple Internet users in real time.

In particular, the Internet Relay Chat (IRC) service is one example of instant messaging that enables an Internet user to participate in an on-line conversation in real time with other users. An IRC channel, maintained by an IRC server, transmits the text typed by each user who has joined the channel to the other users who have joined the channel. An IRC client shows the names of the currently active channels, enables the user to join a channel, and then displays the other channel participant's words on individual lines so that the user can respond.

Similar to IRC, chat rooms are often available through on-line services and provide a data communication channel that links computers and permits users to converse by sending text messages to one another in real-time.

The benefit of messaging systems, and in particular instant messaging systems, is that a conversation can take place in real time between multiple users utilizing multiple diverse platforms in multiple locations. However, the limitation of current messaging systems is that users are not provided with a method to make corrections to message entries for the record. In particular, users in a messaging system may state something and then later wish to change a statement that is unclear or incorrect, however this type of editing is not provided.

Further, where a messaging session may be recorded as described in U.S. patent application Ser. No. ______ (Attorney Docket No. AUS920010392US1), herein incorporated by reference, a user is not provided with a method to make corrections to recorded message entries. Moreover, where corrections are made to a conversation record, it is typically imperative that others participating in the conversation acknowledge corrections or edits to the conversation record.

In view of the foregoing, it would be advantageous to provide a method, system and program for recording and editing messaging sessions. In particular, it would be advantageous to provide a method, system and program for allowing users participating in a messaging session to edit their own entries and allow other users to acknowledge the edited entries for the record and replicate the record for each participant.

### SUMMARY OF THE INVENTION

In view of the foregoing, it is therefore an object of the present invention to provide an improved method, system and program for performing electronic communications.

It is another object of the present invention to provide a method, system and program for editing messaging sessions.

It is yet another object of the present invention to provide a method, system and program for allowing users to edit message entries previously submitted within a messaging session, such that users are enabled to make corrections to message entries prior to storage.

According to one aspect of the present invention, a particular user from among multiple users associated with a messaging session is enabled to edit a messaging entry previously submitted in the messaging session. The edit to the messaging entry is then saved with the messaging session, such that the particular user is enabled to edit the messaging session prior to saving the messaging session for a record. In addition, the recorded messaging session with the edit to the messaging entry is distributed among the users associated with the messaging session.

All objects, features, and advantages of the present invention will become apparent in the following detailed written description.

### BRIEF DESCRIPTION OF THE DRAWINGS

The novel features believed characteristic of the invention are set forth in the appended claims. The invention itself however, as well as a preferred mode of use, further objects and advantages thereof, will best be understood by reference to the following detailed description of an illustrative embodiment when read in conjunction with the accompanying drawings, wherein:

FIG. 1 depicts one embodiment of a computer system with which the method, system and program of the present invention may advantageously be utilized;

FIG. 2 illustrates a simplified block diagram of a client/server environment in which electronic messaging typically takes place in accordance with the method, system and program of the present invention;

FIG. 3 depicts a block diagram of one embodiment of a messaging server in accordance with the method, system and program of the present invention;

FIG. 4 illustrates a graphical representation of a message session recording in accordance with the method, system and program of the present invention;

FIG. 5 depicts a graphical representation of original, edited, and approval messaging session interfaces in accordance with the method, system and program of the present invention;

FIG. 6 illustrates a high level logic flowchart of a process and program for editing a messaging session in accordance with the method, system and program of the present invention; and

FIG. 7 depicts a high level logic flowchart of the process and program for controlling editing of messaging sessions at a client messaging system in accordance with the method, system and program of the present invention.

### DETAILED DESCRIPTION OF THE PREFERRED EMBODIMENT

A method, system and program are provided for recording messaging session entries and allowing users to edit messaging session entries for storage as a record. A “messaging session” preferably includes, but is not limited to, any combination of voice, graphical, video, and/or text messages, instant and/or delayed, transmitted between multiple users via a network. Messaging sessions may include use of chat rooms, instant messages, IRC, e-mail, conference calling and other network methods of providing a channel for users to communicate within. Further, messaging sessions may include communications such as voice and text transmissions between multiple telephony devices.

In addition, an “edit” of a messaging session may include, but is not limited to, editing the style of message entries, adding message entries, deleting message entries, changing message entries, and translating message entries into a particular language. Further, an edit to a messaging session may be made both during and after a messaging session is recorded.

In the present invention, “the record” preferably includes the recording of message entries within a messaging session in a reliable location. In addition, the record may be transmitted to participants associated with the messaging session. The record may also include edits of messaging entries and approvals of edited messaging entries. Moreover, in the present invention, the record includes each set of edits by each user such that the original version, the most current version, and any version in between may be viewed.

In the following description, for the purposes of explanation, numerous specific details are set forth in order to provide a thorough understanding of the present invention. It will be apparent, however, to one skilled in the art that the present invention may be practiced without these specific details. In other instances, well-known structures and devices are shown in block diagram form in order to avoid unnecessarily obscuring the present invention.

### Hardware Overview

The present invention may be executed in a variety of systems, including a variety of computing systems and electronic devices under a number of different operating systems. In one embodiment of the present invention, the messaging system is a portable computing system such as a notebook computer, a palmtop computer, a personal digital assistant, a telephone or other electronic computing system that may also incorporate communications features that provide for telephony, enhanced telephony, messaging and information services. However, the messaging system may also be, for example, a desktop computer, a network computer, a midrange computer, a server system or a mainframe computer. Therefore, in general, the present invention is preferably executed in a computer system that performs computing tasks such as manipulating data in storage that is accessible to the computer system. In addition, the computer system preferably includes at least one output device and at least one input device.

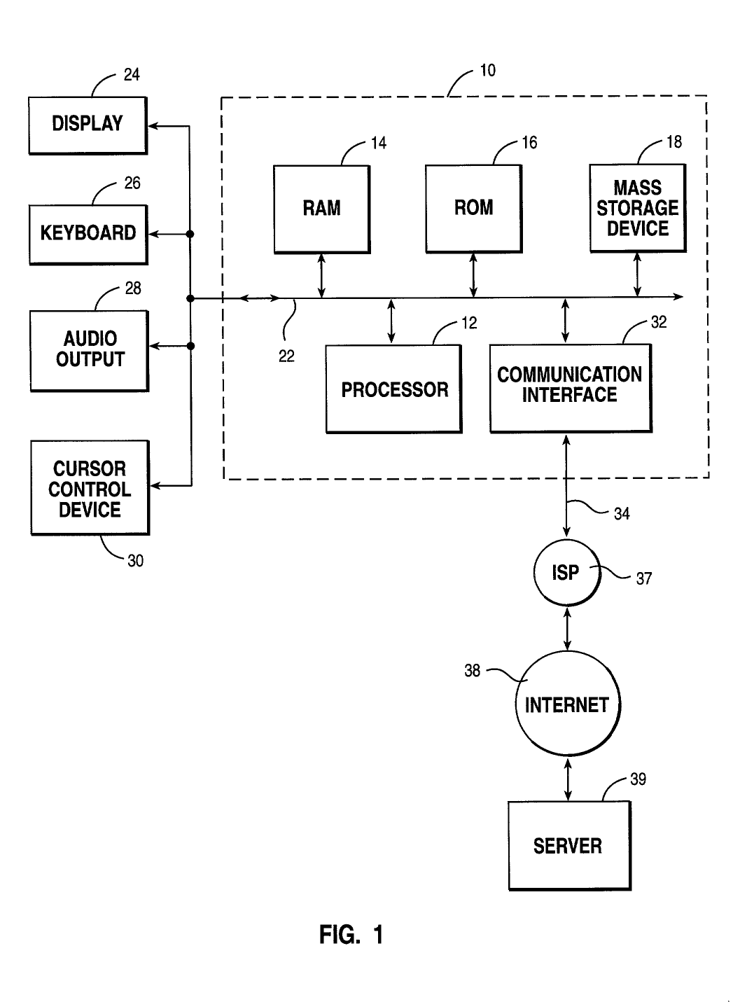

Referring now to the drawings and in particular to FIG. 1, there is depicted one embodiment of a computer system with which the method, system and program of the present invention may advantageously be utilized. Computer system 10 comprises a bus 22 or other communication device for communicating information within computer system 10, and at least one processing device such as processor 12, coupled to bus 22 for processing information. Bus 22 preferably includes low-latency and high-latency paths that are connected by bridges and controlled within computer system 10 by multiple bus controllers.

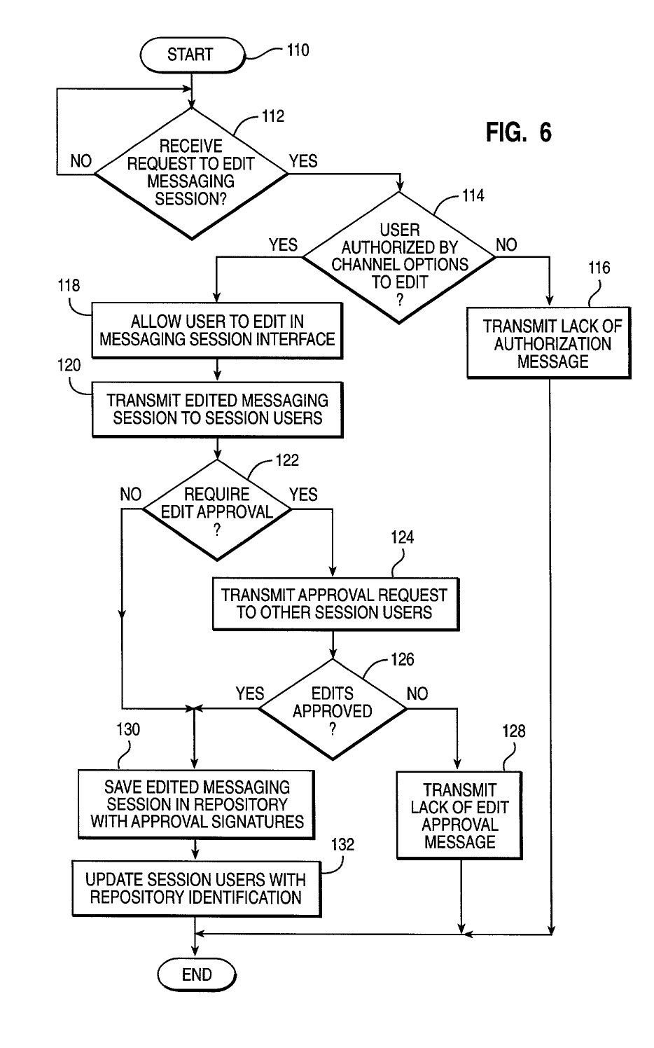

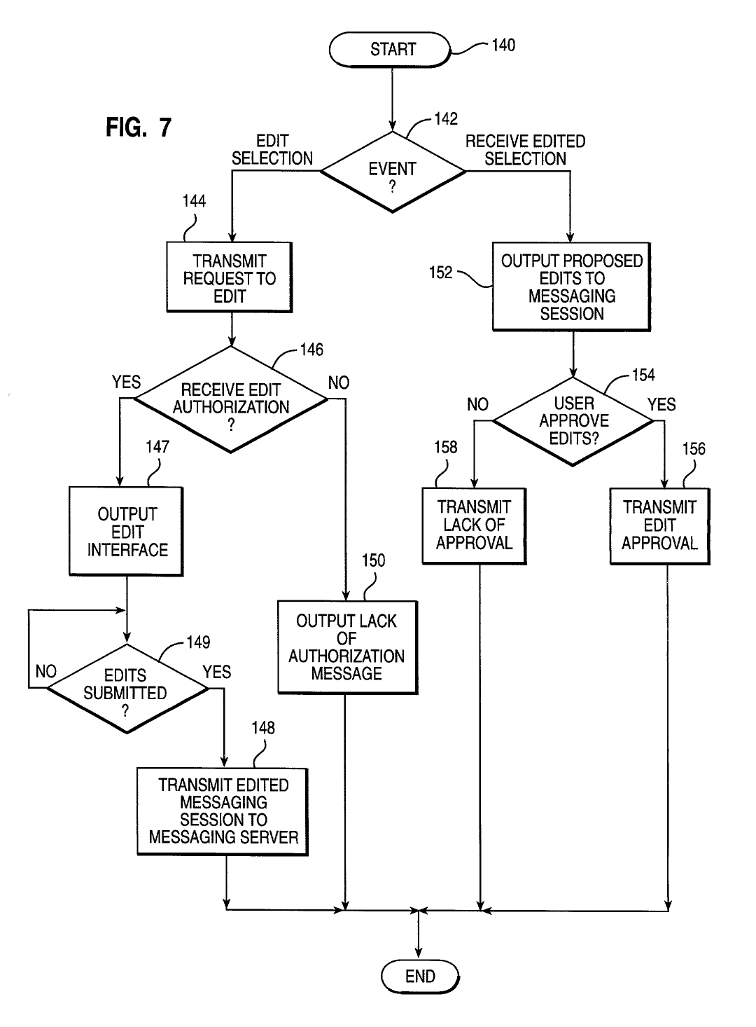

Processor 12 may be a general-purpose processor such as IBM's PowerPC™ processor that, during normal operation, processes data under the control of operating system and application software stored in a dynamic storage device such as random access memory (RAM) 14 and a static storage device such as Read Only Memory (ROM) 16. The operating system preferably provides a graphical user interface (GUI) to the user. In a preferred embodiment, application software contains machine executable instructions that when executed on processor 12 carry out the operations depicted in the flowcharts of FIGS. 6, 7, and others described herein. Alternatively, the steps of the present invention might be performed by specific hardware components that contain hardwire logic for performing the steps, or by any combination of programmed computer components and custom hardware components.

The present invention may be provided as a computer program product, included on a machine-readable medium having stored thereon the machine executable instructions used to program computer system 10 to perform a process according to the present invention. The term “machine-readable medium” as used herein includes any medium that participates in providing instructions to processor 12 or other components of computer system 10 for execution. Such a medium may take many forms including, but not limited to, non-volatile media, volatile media, and transmission media. Common forms of non-volatile media include, for example, a floppy disk, a flexible disk, a hard disk, magnetic tape or any other magnetic medium, a compact disc ROM (CD-ROM), a digital video disc-ROM (DVD-ROM), or any other optical medium, punch cards or any other physical medium with patters of holes, a programmable ROM (PROM), an erasable PROM (EPROM), electrically EPROM (EEPROM), a flash memory, any other memory chip or cartridge, or any other medium from which computer system 10 can read and which is suitable for storing instructions. In the present embodiment, an example of non-volatile media is storage device 18. Volatile media includes dynamic memory such as RAM 14. Transmission media includes coaxial cables, copper wire or fiber optics, including the wires that comprise bus 22. Transmission media can also take the form of acoustic or light waves, such as those generated during radio wave or infrared data communications.

Moreover, the present invention may be downloaded as a computer program product, wherein the program instructions may be transferred from a remote computer such as a server 39 to requesting computer system 10 by way of data signals embodied in a carrier wave or other propagation medium via a network link 34 (e.g., a modem or network connection) to a communications interface 32 coupled to bus 22. Communications interface 32 provides a two-way data communications coupling to network link 34 that may be connected, for example, to a local area network (LAN), wide area network (WAN), or as depicted herein, directly to an Internet Service Provider (ISP) 37. In particular, network link 34 may provide wired and/or wireless network communications to one or more networks.

ISP 37 in turn provides data communication services through the Internet 38 or other network. Internet 38 may refer to the worldwide collection of networks and gateways that use a particular protocol, such as Transmission Control Protocol (TCP) and Internet Protocol (IP), to communicate with one another. ISP 37 and Internet 38 both use electrical, electromagnetic, or optical signals that carry digital data streams. The signals through the various networks and the signals on network link 34 and through communication interface 32, which carry the digital data to and from computer system 10, are exemplary forms of carrier waves transporting the information.

Further, multiple peripheral components may be added to computer system 10. For example, an audio output 28 is attached to bus 22 for controlling audio output through a speaker or other audio projection device. A display 24 is also attached to bus 22 for providing visual, tactile or other graphical representation formats. A keyboard 26 and cursor control device 30, such as a mouse, trackball, or cursor direction keys, are coupled to bus 22 as interfaces for user inputs to computer system 10. In alternate embodiments of the present invention, additional input and output peripheral components may be added.

### Messaging Systems Context

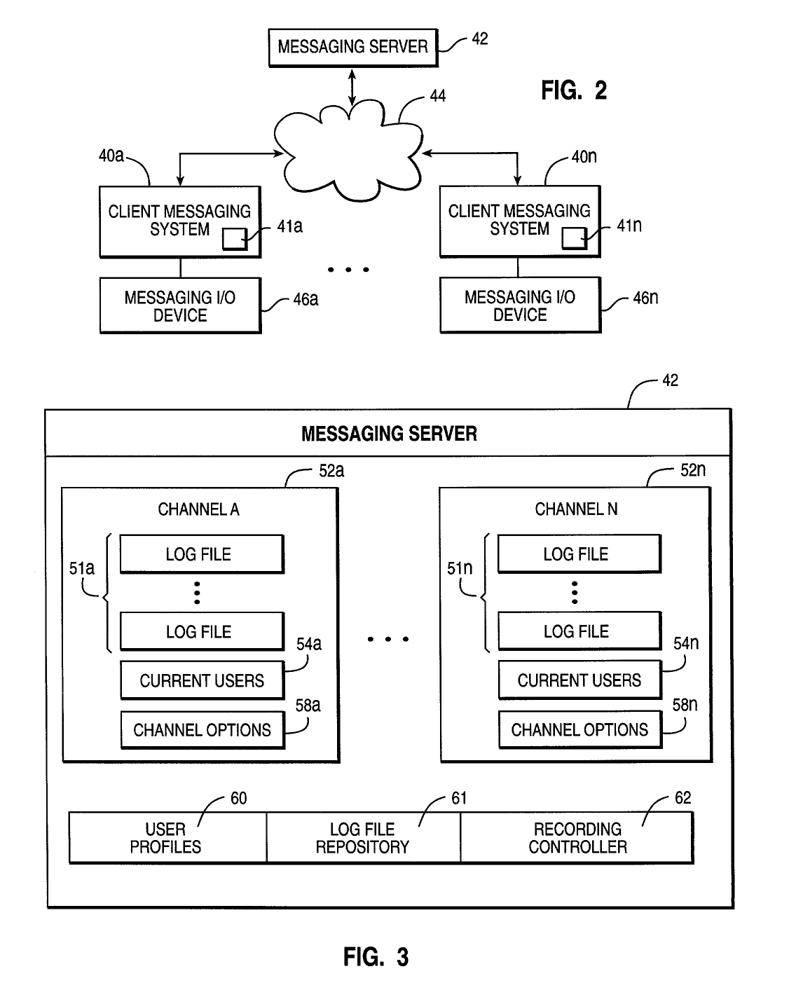

With reference now to FIG. 2, there is depicted a simplified block diagram of a client/server environment in which electronic messaging typically takes place in accordance with the method, system and program of the present invention. The client/server environment is implemented within multiple network architectures. For example, the architecture of the World Wide Web (the Web) follows a traditional client/server modeled environment.

The terms “client” and “server” are used to refer to a computer's general role as a requester of data (the client) or provider of data (the server). In the Web environment, web browsers such as Netscape Navigator typically reside on client messaging systems 40a-40n and render Web documents (pages) served at least one messaging server such as messaging server 42. Additionally, each of client messaging systems 40a-40n and messaging server 42 may function as both a “client” and a “server” and may be implemented utilizing a computer system such as computer system 10 of FIG. 1. Further, while the present invention is described with emphasis upon messaging server 42 controlling a messaging session, the present invention may also be performed by client messaging systems 40a-40n engaged in peer-to-peer network communications via a network 44.

The Web may refer to the total set of interlinked hypertext documents residing on servers all around the world. Network 44, such as the Internet, provides an infrastructure for transmitting these hypertext documents between client messaging systems 40a-40n and messaging server 42. Documents (pages) on the Web may be written in multiple languages, such as Hypertext Markup Language (HTML) or Extensible Markup Language (XML), and identified by Uniform Resource Indicators (URIs) that specify the particular messaging server 42 and pathname by which a file can be accessed, and then transmitted from messaging server 42 to an end user utilizing a protocol such as Hypertext Transfer Protocol (HTTP). Web pages may further include text, graphic images, movie files, and sounds as well as Java applets and other small embedded software programs that execute when the user activates them by clicking on a link.

Advantageously, in the present invention, a client enters a message via one of messaging input/output (I/O) device 46a-46n for a messaging session at a client messaging system such as client messaging system 40a. The message entry is transmitted to messaging server 42. Messaging server 42 then distributes the message entry to the other users participating in the messaging session via network 44.

In addition, in the present invention, a user at each of client messaging systems 40a-40n may request to record or log a messaging session. Further, a user at each of client messaging systems 40a-40n may request to messaging server 42 to edit message entries already submitted. Preferably each user is only allowed to edit message entries associated with that user. Messaging server 42 may then transmit requests to approve the edits to other users participating in the messaging session at client messaging systems 40a-40n. Depending on the approvals received at messaging server 42 from client messaging systems 40a-40n, the edited entries in the messaging session are recorded at messaging server 42, client messaging systems 40a-40n, or another data storage system accessible via network 44.

In another embodiment, edits to a messaging session may also be accessible to client messaging systems 40a-40n as files, in a directory, that is accessible to users associated with the messaging session. A user may scroll through multiple versions of the edited messaging session within the directory utilizing keyboard commands, voice commands, or a graphical interface. The multiple versions may include, but are not limited to, the original version, a version for each edit requested, and a current version based on all the approved edits. Further, a user may sort the multiple versions based on multiple types of criteria including, but not limited to, by time, by user, by size, and other sortable criteria.

Further, the edits to a messaging session may be transmitted as e-mail to participants in the messaging session, where the email application functioning on the client messaging system automatically determines that the e-mail contains messaging session edits and outputs the edits according to user preferences. Moreover, the present invention may utilize a traditional IRC channel for transmitting message entries and a additional IRC channels for transmitting edit requests, transmitting approvals of edits, and transmitting current edited versions of the messaging session among users.

In addition, particularly where edits are made to a messaging session after the messaging session has concluded, a special client rotator application may be utilized by a messaging server or other server to determine the location of each user who participated in the messaging session and initiate a socket connection which each user for transmitting requests to approve edits and edited versions of recorded messaging sessions. Furthermore, other types of messaging systems may be utilized to implement the present invention, as will be understood by one skilled in the art.

Advantageously, the steps of requesting to record and requesting to edit recordings are performed by an application executing in each of client messaging systems 40a-40n, such as client recording applications 41a-41n. In addition, client recording applications 41a-41n may control the functions performed by messaging server 42 where a peer-to-peer network is utilized.

Referring now to FIG. 3, there is illustrated a block diagram of one embodiment of a messaging server in accordance with the method, system and program of the present invention. As depicted, messaging server 42 includes a messaging controller 62 that is provided to control the process steps of messaging server 42 as will be further described.

Messaging server 42 also includes multiple channels 52a-52n. Each of channels 52a-52n may represent a separate information path within messaging server 42 in which multiple users may participate in a messaging session. Messaging server 42 may have a defined number of channels 52a-52n or may allow users to create new channels as needed. In particular, channels provide network paths between multiple users for both voice and text communications. Each of channels 52a-52n may further include multiple distinguishable topics.

In addition, each of channels 52a-52n preferably includes a table of current users 54a-54n. As a user selects to participate in channels 52a-52n, the user's identification is added to the table of current users 54a-54n for that channel.

Preferably, as messaging server 42 receives messages, they may be stored according to the channel, topic, and user and then distributed to each of the users participating in that channel. Where both voice and text are being utilized in a single messaging session, messaging server 42 may transmit both voice and text or messaging server 42 may translate all entries into either voice or text before distributing entries to the users participating in the channel.

Messaging entries are preferably stored within each channel in one of log files 51a-51n. Advantageously, multiple users may request to record different selections of the message entries for a messaging session where a new log file is utilized for each request. For example, one user may request to record message entries from a selection of users from among all the users while another user may request to record message entries during a particular time interval of the messaging session.

When a user has finished recording the desired portions of a messaging session, the log file for that user request may be stored in a log file repository 61. Advantageously, log file repository 61 catalogs messaging session recordings such that multiple users may easily access the recordings. While in the present invention log file repository 61 is depicted within messaging server 42, in alternate embodiments log file repository 61 may be included in an alternate server system. In addition, alternatively, log files may be transmitted from messaging server 42 to client messaging systems for storage.

A user may request via one of client messaging systems 40a-40n to messaging server 42 to edit message entries in log files 51a-51n during a messaging session or in a log file already stored in log file repository 61. In particular, in requesting to edit a message entry, other users may approve the edit via client messaging systems 40a-40n. The edited message entry and other user approvals are stored together with the log file.

In the present embodiment, a user participating in a messaging system is typically requesting to edit a message entry. However, in addition, users that were scheduled to participate in a messaging session or users who have access to a messaging session without participating may request to edit a messaging session by adding entries thereto. Advantageously, by allowing users to later add entries to the messaging session, a user who was scheduled to participate in the messaging session, but who was unable to participate because of time constraints or device constraints, may later participate in the messaging session. Preferably, message entries added after the messaging session has been recorded are approved by other users associated with the messaging session.

Messaging server 42 includes a user profiles database 60 that includes profile information for each user, including, but not limited to, a user identification, a name, an e-mail address, editing preferences and a user history recorded as the user participates in messaging sessions. The user identification stored in user profiles 60 during registration is utilized across multiple channels for identifying entries provided by that user.

Messaging controller 62 is advantageously a software application executing within messaging server 42 in order to control recording of message entries and editing of message entries according to user editing preferences and channel options.

Channel options are included with each channel as depicted by channel options 58a-58n. Channel options preferably include authorization levels required to edit message entries within a messaging session and approvals by other users required to store the edited message entries. In addition, channel options may include a selection of users associated with the channel. Advantageously, channel options may be selected when a user requests a new channel. Alternatively, a user may select a channel based on the authorization levels set in the channel options for that channel. Moreover, a business or other network service provider may automatically set channel options for channels.

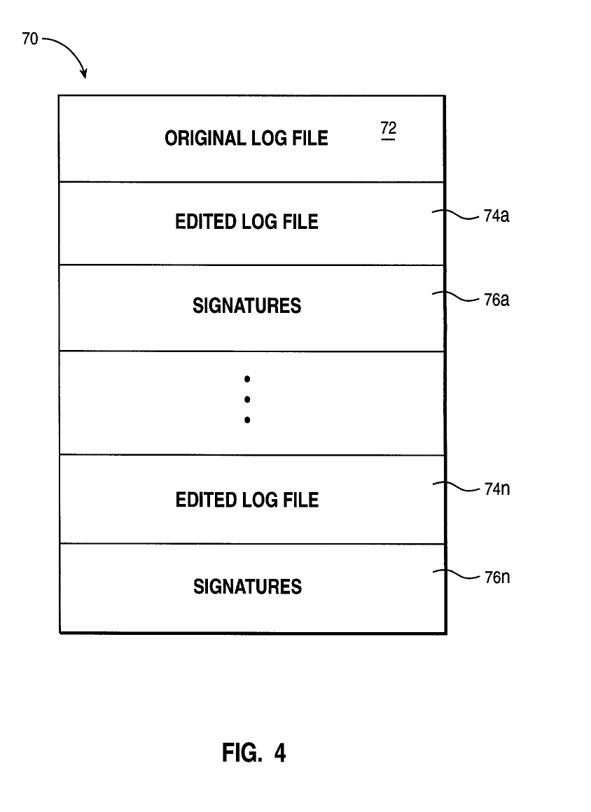

With reference now to FIG. 4 there is illustrated a graphical representation of a message session recording in accordance with the method, system and program of the present invention. As depicted, message session recording 70 includes an original log file 72, edited log files 74a-74n, and signatures 76a-76n approving edited log files 74a-74n. In particular, original log file 72 is the recording of the originally submitted message entries for a messaging session. Each of edited log files 74a-74n includes edited message entries by at least one user who participated in the messaging session. Upon editing a log file, a request for approval is preferably transmitted to other users participating in the messaging session. Signatures 76a-76n contains the digital signatures of those users approving each of the edited log files 74a-74n. In the present invention, while digital signatures are utilized in the present invention to indicate user approval of edits, in alternate embodiments, alternate types of user approvals may be utilized.

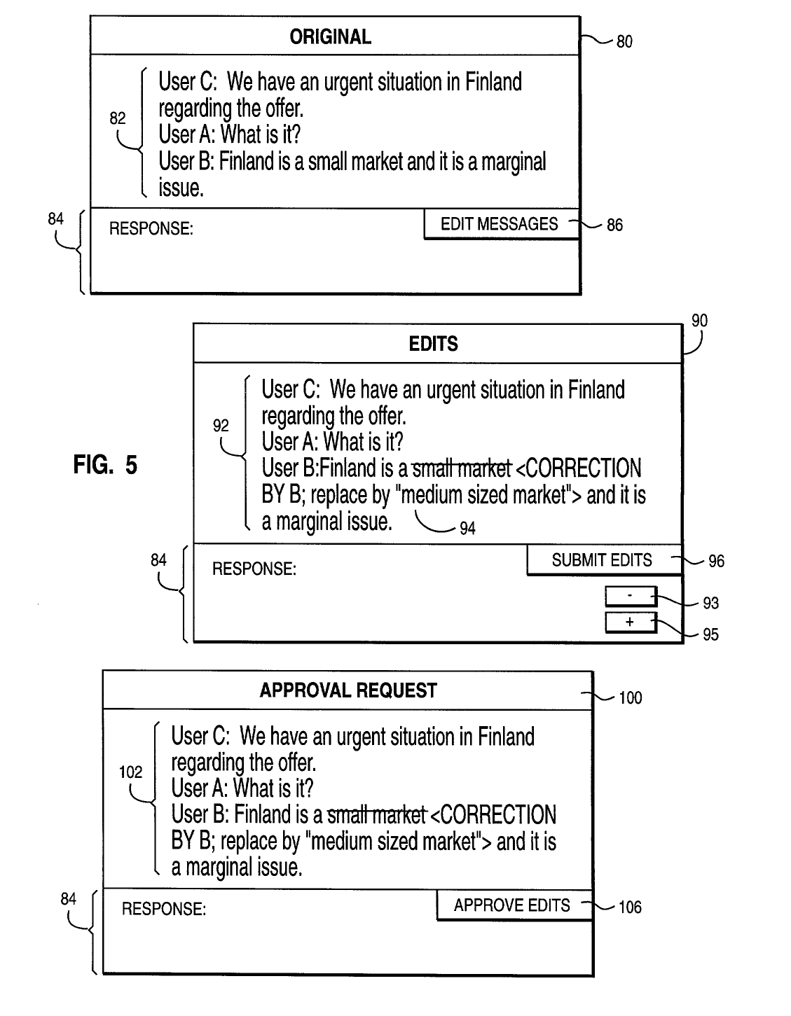

Referring now to FIG. 5, there is depicted a graphical representation of original, edited, and approval messaging session interfaces in accordance with the method, system and program of the present invention. As depicted, an original messaging session interface 80 includes original message entries 82, a response block 84 and a selectable button 86 for editing messages. In addition, an edited messaging session interface 90 includes edited message entries 92, edit 94, response block 84, and a selectable button 96 for submitting edits. Further, an approval messaging session interface 100 includes approval message entries 102, a response block 84, and a selectable button 106 for approving edits.

Response block 84 is provided to allow a user to enter either a textual, graphical, or audible message to be included in the messaging session. In addition, response block 84 may be utilized as an interface into which a user may enter edit requests.

First, original messaging session interface 80 includes original message entries 82 as submitted by users A, B, and C. Entries may be illustrated with distinguishable attributes according to user. For example, entries by user A may be rendered in a first distinguishable color while entries by user B are rendered in a second distinguishable color. In addition, although, not depicted, multiple topics within a single channel may be graphically distinguished.

In response to a user selection of selectable button 86, the user is provided with tools to edit messages submitted by that user. For example, if user B selects selectable button 86, then user B is enabled to edit message entries submitted by user B within original message entries 82.

Next, edited messaging session interface 90 includes edited message entries 92, here as edited by user B. In particular, edit 94 depicts a correction made by user B to the words “small market”. In the present example, words to be deleted are indicated by a strike through while words to be added are in parenthesis. A user may select delete tool 93 to select words to strike through and add tool 95 to select words to add. However, in alternate embodiments, alternate editing tools and formats may be utilized. For example, it would be advantageous to allow editing tools for editing the style of a recorded messaging session to be placed in a formal document.

In alternate embodiments, an alternate graphical manner in which edits are depicted may be utilized. For example, each user may select attributes to be assigned to edits such that edits are distinguishable according to user by color, text or other distinguishable attribute. In addition, the messaging server may assign distinguishable attributes to each user's edits. Further, each user's edits may be made indistinguishable for a final version.

In response to a user selection of selectable button 96, the edits made by user B are submitted to the messaging server for other users to approve. The messaging server will determine which users participating in the messaging session are required to approve the edits submitted by user B. In alternate embodiments, alternate users may submit edits. Moreover, multiple users may submit multiple message entry edits.

Thereafter, approval messaging session interface 100 includes approval message entries 102, for approval in the present example by user A. In the present example, the edits are depicted as formatted by user B. However, in alternate embodiments, alternate formats may be utilized to depict edits for approval. For example, the distinguishable colors and fonts may be utilized to depict edited message entries.

In response to a user selection of selectable button 106, an approval by user A for the edits made by user B is submitted. In particular, when a user approves edits, the user's digital signature may be transmitted with the approval such that a verifiable approval is stored with the edited message entries. In addition, alternative types of user verifications may be utilized. Following approval of the edits, a copy of the edited recording may be transmitted to each of the participants in the messaging session.

With reference now to FIG. 6, there is depicted a high level logic flowchart of a process and program for editing a messaging session in accordance with the method, system and program of the present invention. As illustrated, the process starts at block 110 and thereafter proceeds to block 112. Block 112 depicts a determination as to whether or not a request to edit a messaging session is received. If a request to edit a messaging session is not received, then the process iterates at block 112. If a request to edit a messaging session is received, then the process passes to block 114.

Block 114 illustrates a determination as to whether or not the user requesting to edit is authorized by the channel options to edit the messaging session. If the user is authorized to edit, then the process passes to block 118. If the user is not authorized to edit, then the process passes to block 116. Block 116 depicts transmitting a lack of authorization message to the requesting user and, the process ends.

Block 118 depicts allowing a user to edit that user's messages in the messaging session interface. Next, block 120 illustrates transmitting the edited messaging session to session users. Thereafter, block 122 depicts a determination as to whether or not edit approvals are required according to the channel options. If edit approvals are not required, then the process passes to block 130. If edit approvals are required, then the process passes to block 124.

Block 124 illustrates transmitting an approval request to other session users from whom approval is required. Next, block 126 depicts a determination as to whether or not the edits are approved. If the edits are approved, then the process passes to block 130. If the edits are not approved, then the process passes to block 128. Block 128 illustrates transmitting an indicator that there was a lack of approval for the edits, and the process ends.

Block 130 depicts saving the edited messaging session and approval signatures in a log file repository. Next, block 132 illustrates updating the session users with the identification in the repository under which the messaging session is saved, and the process ends. In addition, a copy of the edited messaging session may be transmitted to a selection of users such that each user is provided with a current copy of the messaging session.

Referring now to FIG. 7, there is illustrated a high level logic flowchart of the process and program for controlling editing of messaging sessions at a client messaging system in accordance with the method, system and program of the present invention. As depicted, the process starts at block 140 and thereafter proceeds to block 142. Block 142 illustrates a determination as to what event occurred when an event occurs. If a selection to edit is received, then the process passes to block 144. If an edited message entry is received, then the process passes to block 152.

Block 144 depicts transmitting a request to edit to the messaging server. Next, block 146 illustrates a determination as to whether or not an edit authorization is received. If an edit authorization is received, then the process passes to block 147. If an edit authorization is not received, then the process passes to block 150. Block 150 depicts outputting a lack of authorization indicator, and the process ends.

Block 147 illustrates outputting an editing interface. Next, block 149 depicts a determination as to whether or not edits are submitted. If edits are not submitted, then the process iterates at block 149. If edits are submitted, then the process passes to block 148. Block 148 illustrates transmitting the edited messaging session to the messaging server, and the process ends.

Block 152 depicts outputting the proposed edits to the messaging session. Next, block 154 illustrates a determination as to whether or not the user approves the edits. If the user approves the edits, then the process passes to block 156 which depicts transmitting an edit approval to the messaging server, and the process ends. In particular, in transmitting an edit approval, a digital signature or other user verification may be transmitted. If the user does not approve the edits, then the process passes to block 158 which illustrates transmitted a lack of approval to the messaging server, and the process ends.

While the invention has been particularly shown and described with reference to a preferred embodiment, it will be understood by those skilled in the art that various changes in form and detail may be made therein without departing from the spirit and scope of the invention.

What is claimed is:

1. A method for recording a messaging session, said method comprising the steps of:
enabling a particular user to edit a messaging entry previously submitted in a messaging session, wherein at least one other user has participated in said messaging session; and
saving said edit to said messaging entry with said messaging session, such that said particular user is enabled to edit said messaging session prior to saving as a record.

2. The method for recording a messaging session according to claim 1, said method further comprising the step of:
receiving said edit at a messaging server communicatively connected via a network to a plurality of client messaging systems accessible to said users.

3. The method for recording a messaging session according to claim 1, said method further comprising the step of:
receiving said edit at a particular client messaging system accessible to said particular user communicatively connected via a network to a plurality of client messaging systems accessible to said users.

4. The method for recording a messaging session according to claim 1, said step of enabling a particular user to edit a messaging entry, further comprising the step of:
in response to channel options for said messaging session allowing editing by said particular user, enabling said particular user to edit said messaging entry.

5. The method for recording a messaging session according to claim 1, said method further comprising the step of:
providing an interface to said particular user for entering said edit to said messaging entry.

6. The method for recording a messaging session according to claim 1, said method further comprising the steps of:
submitting a request to said at least one other user to approve said edit of said messaging entry; and
in response to receiving an approval from said at least one other user, storing said messaging session with said edit of said messaging entry.

7. The method for recording a messaging session according to claim 6, said method further comprising the steps of:
receiving said approval with a digital signature corresponding to said at least one other user; and
storing said digital signature with said edit of said messaging entry.

8. The method for recording a messaging session according to claim 1, said method further comprising the step of:
distributing said messaging session with said edit to said message entry to said at least one other user.

9. A system for recording a messaging session, said system comprising:
a server system communicatively connected to a network;
said server system further comprising:
means for enabling a particular user to edit a messaging entry previously submitted in a messaging session, wherein at least one other user has participated in said messaging session; and
means for saving said edit to said messaging entry with said messaging session, such that said particular user is enabled to edit said messaging session prior to saving as a record.

10. The system for recording a messaging session according to claim 9, wherein said server system is communicatively connected via said network to a plurality of client messaging systems accessible to said users.

11. The system for recording a messaging session according to claim 9, said server system further comprising:
means for enabling said particular user to edit said messaging entry, in response to channel options for said messaging session allowing editing by said particular user.

12. The system for recording a messaging session according to claim 9, said server system further comprising:
means for providing an interface to said particular user for entering said edit to said messaging entry.

13. The system for recording a messaging session according to claim 9, said server system further comprising:
means for submitting a request to said at least one other user to approve said edit of said messaging entry; and
means for storing said messaging session with said edit of said messaging entry, in response to receiving an approval from said at least one other user.

14. The system for recording a messaging session according to claim 13, said server system further comprising:
means for receiving said approval with a digital signature corresponding to said at least one other user; and
means for storing said digital signature with said edit of said messaging entry.

15. The system for recording a messaging session according to claim 9, said server system further comprising:
means for distributing said messaging session with said edit to said message entry to said at least one other user.

16. A program for recording a messaging session, residing on a computer usable medium having computer readable program code means, said program comprising:
means for enabling a particular user to edit a messaging entry previously submitted in a messaging session, wherein at least one other user has participated in said messaging session; and
means for saving said edit to said messaging entry with said messaging session, such that said particular user is enabled to edit said messaging session prior to saving as a record.

17. The program for recording a messaging session according to claim 16, said program further comprising:
means for enabling said particular user to edit said messaging entry, in response to channel options for said messaging session allowing editing by said particular user.

18. The program for recording a messaging session according to claim 16, said program further comprising:
means for providing an interface to said particular user for entering said edit to said messaging entry.

19. The program for recording a messaging session according to claim 16, said program further comprising:
means for submitting a request to said at least one other user to approve said edit of said messaging entry; and
means for storing said messaging session with said edit of said messaging entry, in response to receiving an approval from said at least one other user.

20. The program for recording a messaging session according to claim 19, said program further comprising:
means for receiving said approval with a digital signature corresponding to said at least one other user; and
means for storing said digital signature with said edit of said messaging entry.

21. The program for recording a messaging session according to claim 16, said program further comprising:
means for distributing said messaging session with said edit to said message entry to said at least one other user.

22. A method for editing previously submitted message entries in a messaging session, said method comprising the steps of:
requesting to edit a previously submitted entry in a messaging session; and
in response to receiving editing authorization, submitting an edit to said message entry, such that a recording of said messaging session is adjusted according to said edit to said message entry.

23. The method for editing previously submitted message entries in a messaging session according to claim 22, said method further comprising the step of:
submitting said request to edit a previously submitted entry from a client messaging system communicatively connected via a network to a messaging server.

24. The method for editing previously submitted message entries in a messaging session according to claim 22, said method further comprising the step of:
submitting said request to edit a previously submitted entry from a particular client messaging system communicatively connected via a network to at least one other client messaging system.

25. The method for editing previously submitted message entries in a messaging session according to claim 22, said method further comprising the step of:
in response to receiving approvals for said edit from at least one other user associated with said messaging session, storing said messaging session with said edit as a record accessible to said at least one other user.

26. A system for editing previously submitted message entries in a messaging session, said system comprising:
a client messaging system communicatively connected to a network;
said client messaging system further comprising:
means for requesting to edit a previously submitted entry in a messaging session; and
means for submitting an edit to said message entry, in response to receiving editing authorization, such that a recording of said messaging session is adjusted according to said edit to said message entry.

27. The system for editing previously submitted message entries in a messaging session according to claim 26, wherein said client messaging system is communicatively connected via a network to a messaging server.

28. The system for editing previously submitted message entries in a messaging session according to claim 26, said client messaging system further comprising:
means for storing said messaging session with said edit as a record accessible to said at least one other user, in response to receiving approvals for said edit from at least one other user associated with said messaging session.

29. A program for editing previously submitted message entries in a messaging session, residing on a computer usable medium having computer readable program code means, said program comprising:
means for requesting to edit a previously submitted entry in a messaging session; and
means for submitting an edit to said message entry, in response to receiving editing authorization, such that a recording of said messaging session is adjusted according to said edit to said message entry.

30. The program for editing previously submitted message entries in a messaging session according to claim 29, said program further comprising:
means for storing said messaging session with said edit as a record accessible to said at least one other user, in response to receiving approvals for said edit from at least one other user associated with said messaging session.
